(19) United States
(12) Patent Application Publication
(10) Pub. No.: US 2012/0235875 A1
(43) Pub. Date: Sep. 20, 2012

(54) SMALL SHORTED PATCH ANTENNA

(75) Inventors: TZU-CHIEH HUNG, TAIPEI (TW); SAOU-WEN SU, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/224,799

(22) Filed: Sep. 2, 2011

(30) Foreign Application Priority Data
Mar. 18, 2011 (CN) 201110069642.3

(51) Int. Cl. H01Q 1/48

(52) U.S. Cl. 343/846

(57) ABSTRACT

A patch antenna includes a metal plate having two parallel long edges and two short edges connected together. The metal plate has a first fold line and a second fold line that are parallel to the two short edges and that partition the metal plate into a ground portion and a radiating portion, the former being longer than the latter but not longer than twice the length of the latter. The metal plate has a shorting portion between the first and second fold lines. A feed-in portion extends from the second fold line toward the first fold line, forms a first slit with the ground portion, and forms a second slit with the shorting portion. Both slits are interconnected. The shorting portion is perpendicular with respect to the ground portion. The radiating portion is perpendicular with respect to the shorting portion and the feed-in portion.

### CROSS-REFERENCE TO RELATED APPLICATION

This application claims priority to Chinese Application No 201110069642.3, filed on Mar. 18, 2011.

### BACKGROUND OF THE INVENTION

1. Field of the Invention

The invention relates to a concealed antenna, more particularly to a small shorted patch antenna.

2. Description of the Related Art

FIG. 1 shows a conventional patch antenna 1 with half wavelength resonant metal plate structure. Apart from having a large area, the patch antenna 1 usually needs to be integrated with a ground plane 11 of a system printed circuit board (PCB) 10 and cannot be a stand-alone component inside an electronic device, thus resulting in inflexibility of the position to which the patch antenna 1 can be installed. FIG. 2 shows a conventional inverted-F patch antenna 2, which is a modification of the aforesaid patch antenna 1. In the design of the patch antenna 2, an additional shorting portion 21 helps impedance matching of the antenna and effectively decreases area of a radiator body 22. However the patch antenna 2 has a feed-in portion 23 and the shorting portion 21 that are not disposed on the same side, and that may need to be integrated with a ground plane 24 on a system PCB 20, which is still not flexible in terms of the position to which the patch antenna 2 can be installed.

U.S. Pat. No. 6,600,448B2 discloses a patch antenna fed by a small coaxial line where the patch antenna and a system ground plane can be individually installed inside an electronic device, giving flexibility in the position to which the patch antenna can be installed. However, this type of patch antenna can only be disposed on one side of a metallic object. If the patch antenna is disposed directly on top of the metallic object, impedance matching and radiation efficiency of the patch antenna would be affected.

### SUMMARY OF THE INVENTION

Therefore, an object of the present invention is to provide a small shorted patch antenna that is flexible in terms of installation position and that is suitable for installation inside electronic products.

According to a first aspect of the present invention, a shorted patch antenna comprises a metal plate having two parallel long sides and two short sides connecting to the two parallel long sides. The metal plate further has a first fold line and a second fold line that are parallel to the two short sides of the metal plate and that partition the metal plate into a ground portion on one side of the first fold line and a radiating portion on one side of the second fold line. The ground portion has a length longer than a length of the radiating portion and not longer than twice the length of the radiating portion.

The metal plate further has a shorting port ion between the first fold line and the second fold line and connecting the ground portion and the radiating portion, and a feed-in portion extending from the second fold line toward the first fold line. The feed-in portion forms a first slit with the ground portion, and forms a second slit with the shorting portion. The first slit is connected to the second slit.

The shorting portion is folded relative to the ground portion along the first fold line such that the shorting portion and the feed-in portion are substantially perpendicular with respect to the ground portion.

The radiating portion is folded relative to the shorting portion and the feed-in portion along the second fold line such that the radiating portion is substantially perpendicular with respect to the shorting portion and the feed-in portion and such that the radiating portion is spaced apart from a surface of the ground portion.

The two short sides are located on a same side of the first fold line.

According to a second aspect of the present invention, a shorted patch antenna comprises a ground portion, a radiating portion, a shorting portion and a feed-in portion.

The ground portion has a first long edge and a second long edge opposite to each other, and a first short edge and a second short edge opposite to each other and each connected to the first long edge and the second long edge.

The radiating portion is spaced apart from a surface of the ground portion and has a third long edge and a fourth long edge opposite to each other, and a third short edge and a fourth short edge opposite to each other and each connected to the third long edge and the fourth long edge.

The third short edge is aligned with the first short edge.

The second short edge and the fourth short edge are located on a same side of the first short edge.

The shorting portion has a first side connected to the first short edge of the ground portion, and a second side opposite to the first side and connected to the third short edge of the radiating portion.

The feed-in portion is connected to the third short edge of the radiating portion, extends from the third short edge towards the first short edge, forms a first slit with the first short edge, and forms a second slit with the shorting portion.

The first slit and the second slit are interconnected.

According to a third aspect of the present invention, a patch antenna comprises a ground portion, a radiating portion, a shorting portion and a feed-in portion.

The ground portion has a first long edge and a second long edge opposite to each other, and a first short edge and a second short edge opposite to each other and each connected to the first long edge and the second long edge.

The radiating portion is spaced apart from a surface of the ground portion and has a third long edge and a fourth long edge opposite to each other, and a third short edge and a fourth short edge opposite to each other and each connected to the third long edge and the fourth long edge.

The third long edge is aligned with the first long edge. The second short edge and the fourth short edge are located on a same side of the first short edge.

The shorting portion has a first side connected to the first long edge of the ground portion, and a second side opposite to the first side and connected to the third long edge of the radiating portion. The feed-in portion is connected to the third long edge of the ground portion, extends from the third long edge towards the first long edge, forms a first slit with the first long edge, and forms a second slit with the shorting portion. The first slit and the second slit are interconnected.

The length of the ground portion is longer than the length of the radiating portion and shorter than twice the length of the radiating portion. Preferably, the length of the ground portion is 1.6 times the length of the ground portion.

Preferably, each of the first slit and second slit has a slit width of 1 mm.

The effect of the present invention is by stamping a single metal plate to form the first slit and the second slit between the ground portion and the radiating portion and by folding of the shorting portion and the radiating portion along the first fold line and the second fold line respectively, a small shorted patch antenna is formed. Not only is the structure of the antenna easy and inexpensive to make, the shorting portion and the feed-in portion are both on the same side of the antenna, allowing flexibility in the installation of the antenna inside an electronic device.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional patch antenna;

FIG. 2 is a schematic view of a conventional inverted-F patch antenna;

FIG. 3 is a schematic view of a small shorted patch antenna, according to the first embodiment of the present invention in an unfolded state;

FIG. 4 is a schematic view showing the dimensions of the small shorted patch antenna, according to the first embodiment of the present invention;

FIG. 5 is a perspective view of the small shorted patch antenna, according to the first embodiment of the present invention;

FIG. 6 is a plot of return loss vs frequency, obtained for the first embodiment of the present invention;

FIG. 7a is a chart showing the radiation pattern on the x-z plane of the first embodiment operating at 2442 MHz;

FIG. 7b is a chart showing the radiation pattern on the x-y plane of the first embodiment operating at 2442 MHz;

FIG. 7c is a chart showing the radiation pattern on the y-z plane of the first embodiment operating at 2442 MHz;

FIG. 8a shows the radiation pattern of the first embodiment operating at 2400 MHz;

FIG. 8b shows the radiation pattern of the first embodiment operating at 2484 MHz;

FIG. 8c shows the radiation pattern of the first embodiment operating at 2442 MHz;

FIG. 9 is a plot showing antenna gain and radiation efficiency vs frequency, obtained for the first embodiment of the present invention;

FIG. 10 is a schematic view of the small shorted patch antenna, according to the second embodiment of the present invention in an unfolded state; and

FIG. 11 is a perspective view of the small shorted patch antenna, according to the second embodiment of the present invention.

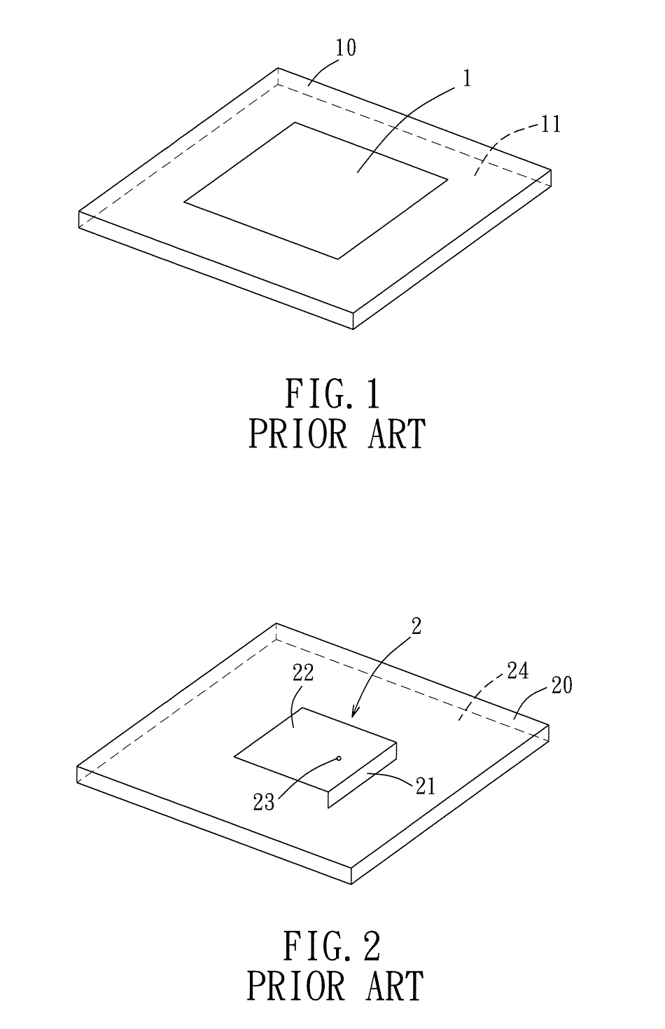

### DETAILED DESCRIPTION OF THE PREFERRED EMBODIMENTS

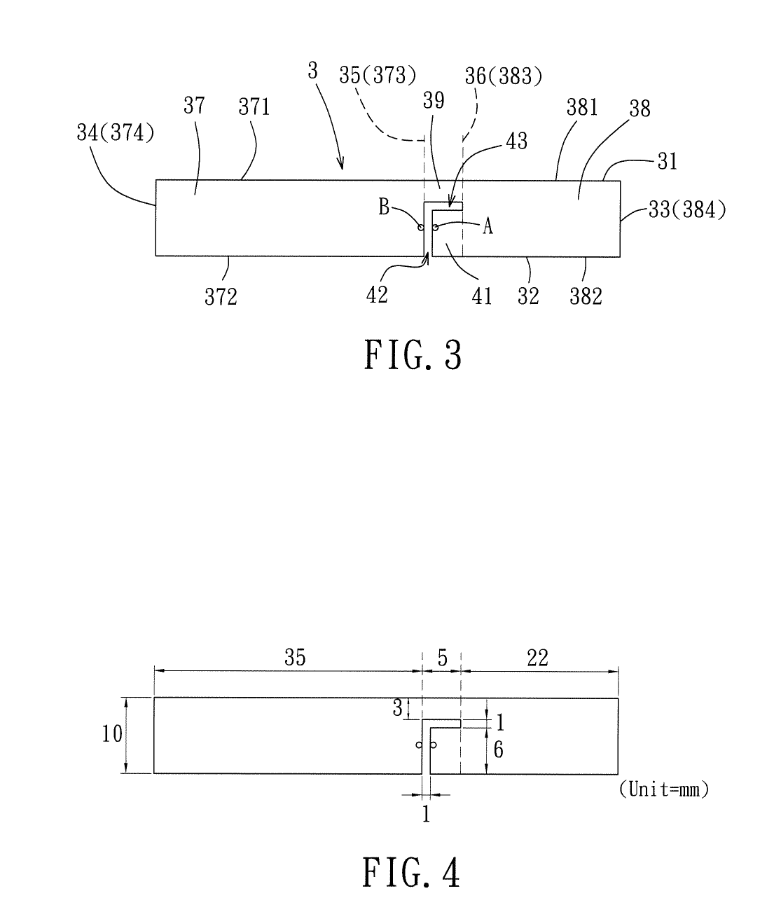

Referring to FIG. 3, the first embodiment of a small shorted patch antenna according to the present invention is shown to comprise a metal plate 3 in a form of a long strip. The metal plate 3 has two long edges 31, 32 that are parallel and equal in length and two short edges 33, 34 that are connected to the two long edges 31, 32.

The metal plate 3 has a first fold line 35 and a second fold line 36 that are parallel to the two short edges 33, 34. The two fold lines 35, 36 partition the metal plate 3 into a ground portion 37 on one side of the first fold line 35 and a radiating portion 38 on one side of the second fold line 36. The ground portion 37 has a length longer than a length of the radiating portion 38 and not longer than twice the length of the radiating portion 38. The ground portion 37 has a first long edge 371 and a second long edge 372 that are arranged parallel to each other and equal in length, and a first short edge 373 and a second short edge 374 that are each connected to the first long edge 371 and the second long edge 372. The radiating portion 38 has a third long edge 381 and a fourth long edge 382 that are arranged parallel to each other and equal in length and a third short edge 383 and a fourth short edge 384 that are each connected to the third long edge 381 and the fourth long edge 382.

Further, between the first fold line 35 (or the first short edge 373) and the second fold line 36 (or the third short edge 383) , there is a shorting portion 39 on the side of a long side 31 and connecting to the ground portion 37 and the radiating portion 38, and a feed-in portion 41 extending from the second fold line 36 (or the third short edge 383) toward the first fold line 35 (or the first short edge 373). That is, the short circuit section 39 and the feed-in portion 41 are located between the first fold line 35 (or the first short edge 373) and the second fold line 36 (or the third short edge 383). Between the feed-in portion 41 and the first short edge 373 of the ground portion 37, there is a first slit 42 extending along the first fold line 35. Between the feed-in portion 41 and the shorting portion 39, there is a second slit 43 that is interconnected with the first slit 42 and that is arranged substantially perpendicular to the first slit 42. The feed in portion 41 near the first short edge 373 of the ground portion 37 makes it convenient to connect a signal line of a small type coaxial cable (not shown) to a feed-in point A on the feed-in portion 41, and to connect a ground line of the small type coaxial cable to a ground point B on the first short edge 373 of the ground portion 37 for feeding a signal.

The dimensions of the metal plate 3, the ground portion 37, the radiating portion 38, the shorting portion 39 and the feed-in portion 41 of the present embodiment are shown in FIG. 4. In this embodiment, the preferred length of the ground portion 37 is 1.6 times the length of the radiating portion 37, and each of the first slit 42 and the second slit 43 has a slit width of 1 mm.

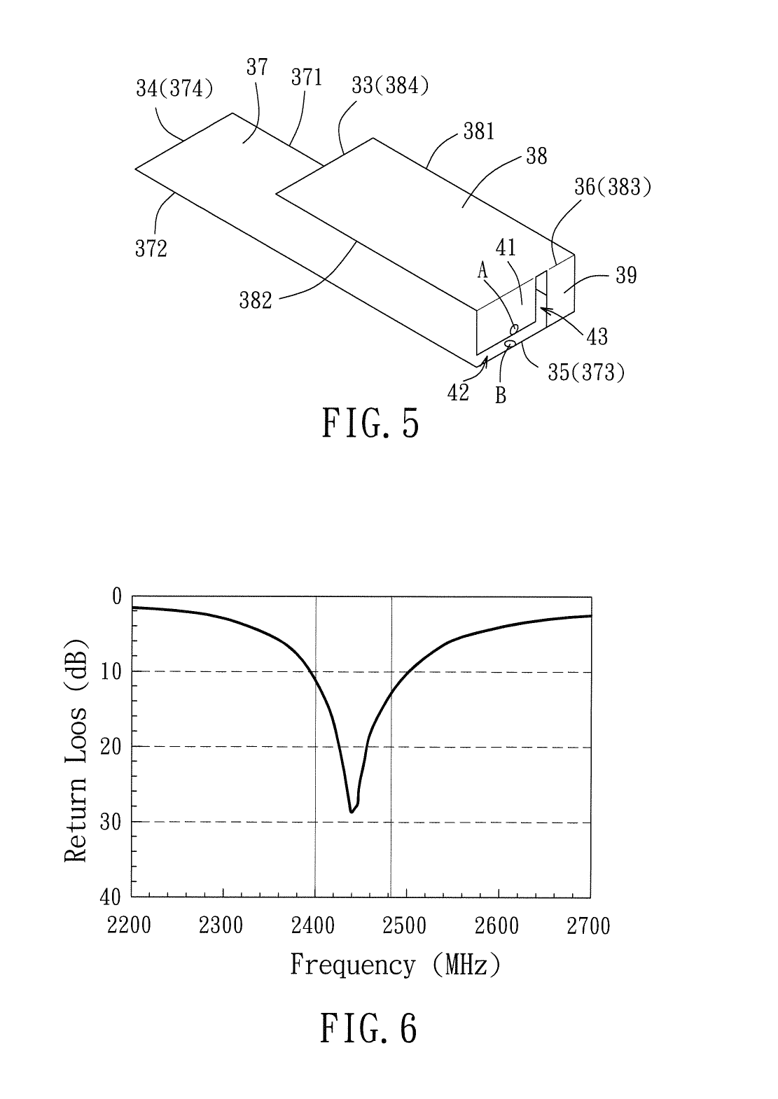

Referring to FIG. 3 and FIG. 5, the shorting portion 39 is folded 90° upward along the first fold line 35, is on the same location of the first short edge 373 of the ground portion 37 as the feed-in portion 41, and is perpendicular with respect to the ground portion 37. The radiating portion 38 is folded 90° toward the direction of the ground portion 37 along the second fold line 36, is perpendicular with respect to the shorting portion 39 and the feed-in portion 41, and is spaced apart from an upper surface of the ground portion 37. Both short edges 33, 34 (or the second short edge 374 and the fourth short edge 384) of the metal plate 3 are located on the same side of the first fold line 35 (or the first short edge 373). The small shorted patch antenna has dimensions of 5 mm×10 mm×35 mm. The radiating portion 38 is of a one quarter wavelength single frequency resonant structure, the operating frequency band being determined by the length thereof (for example, in FIG. 4, the radiating portion 38 has a length of 22 mm).

By adjusting the widths of the first slit 42 and the second slit 43 (for example, in FIG. 4, the first slit 42 and the second slit 43 have a width of 1 mm), it is possible to reach a balance between the capacitance and inductance and therefore an optimum impedance bandwidth.

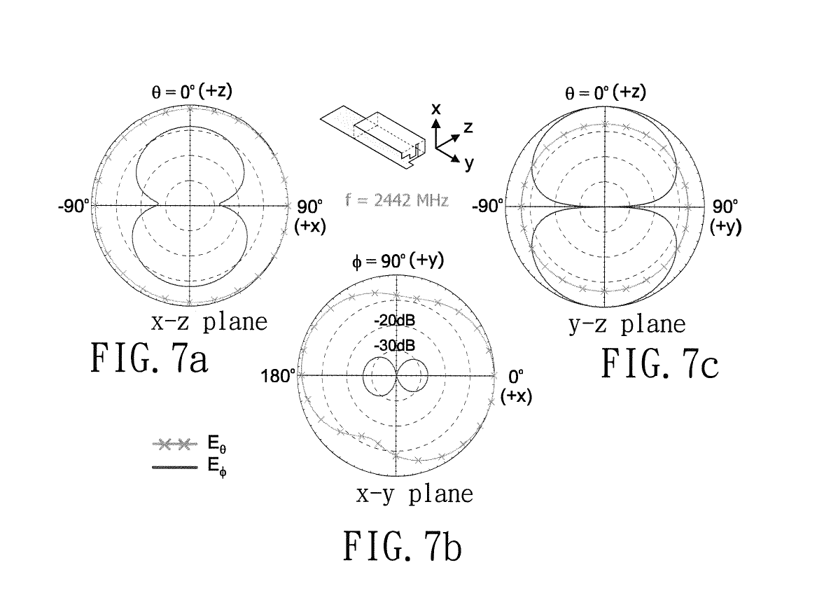

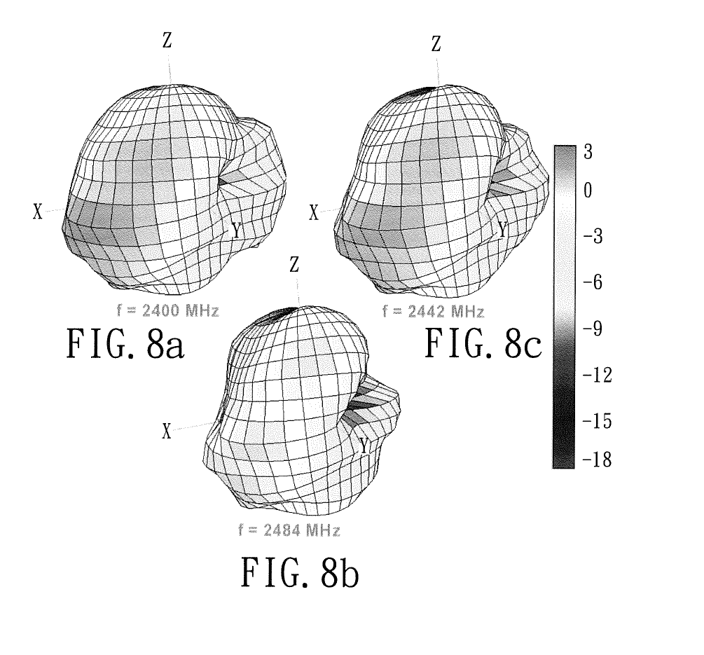

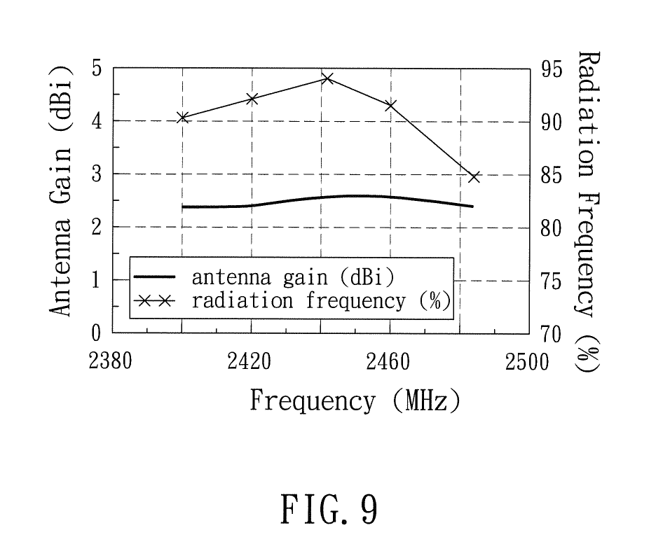

Referring to FIG. 6, as evident from the return loss measurement of the present embodiment, the antenna of the present embodiment operating at 10 dB return loss has an impedance bandwidth of approximately 105 MHz, and covers the operating frequency band of the 2.4 GHz wireless area network. As shown in FIG. 7a-7c and FIG. 8a-8c, the present embodiment presents omnidirectional radiation pattern when the antenna operates at approximately 2.4 GHz. As shown in FIG. 9 of the measurement of the antenna gain and the radiation efficiency, the antenna of the present embodiment has a gain greater than 2 dBi and a radiation efficiency greater than 85% when the present embodiment operates at approximately 2.4 GHz, and is therefore very suitable for installation inside an electronic product as a concealed antenna.

It is apparent from the foregoing that the small shorted patch antenna of the present embodiment has the ground portion 37 and the radiating portion 38 of the same width, and the length of the ground portion 37 is 1.6 times the length of the radiating portion 38, such that the dimensions of the ground portion 37 are close to those of the radiating portion 38. Comparing the ground portion 37 to the ground plane with the conventional patch antenna and the conventional inverted-F patch antenna, the ground portion 37 of the present embodiment is much smaller. Therefore, not only can the small shorted patch antenna of the present embodiment be disposed independently inside an electronic device, it also gives a lot of flexibility and freedom in terms of installation. Moreover, the distal ends of the ground portion 37 and the radiating portion 38 (the second short edge 374 and the fourth short edge 384) both extend in the same direction, while the shorting portion 39 and the feed-in portion 41 are both located on the short edges 373, 383 of the ground portion 37 and the radiating portion 38 that are on the same side. This allows signal feed in when using small type coaxial lines (not shown) to be a lot more convenient, giving even more flexibility in terms of installation inside an electronic device.

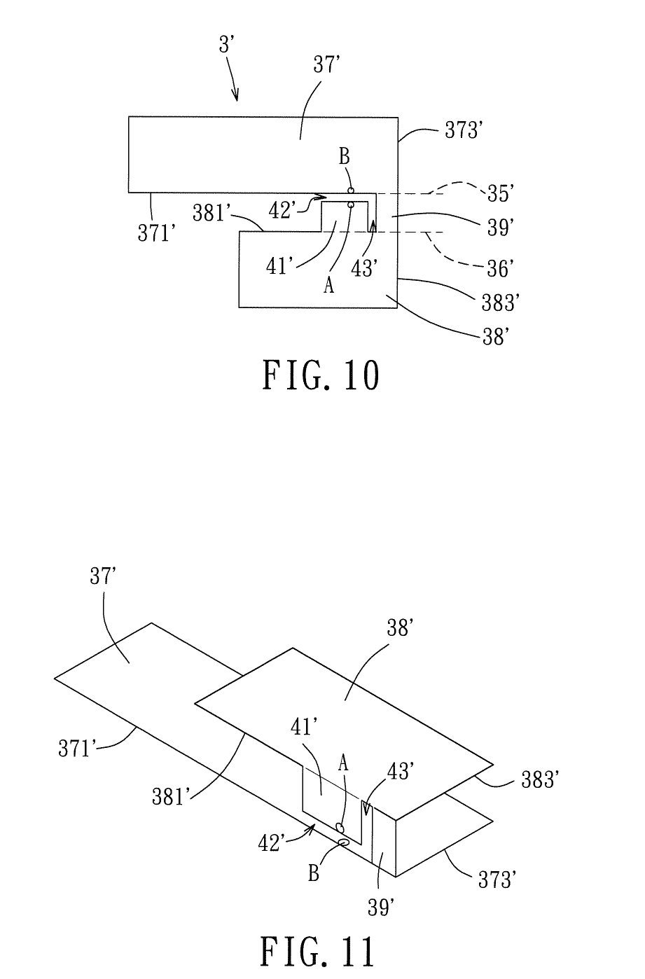

Referring to FIG. 10 and FIG. 11, the second embodiment of the present invention is shown. Like the first embodiment, a metal plate 3′ has a ground portion 37′ and on the side of the first long edge 371′ of the ground portion 37′ is the radiating portion 38′ . The third short edge 383′ of the radiating portion 38′ is aligned with the first short edge 373′ of the ground portion 37′. A shorting portion 39′ connects to the first long edge 371′ of the ground portion 37′ and the third long edge 381′ of the radiating portion 38′. A feed-in portion 41′ extends from the third long edge 381′ of the ground portion 371′ neighboring the radiating portion 38′ toward the first long edge 371′ of the ground portion 37′. A first slit 42′ is formed between the feed-in portion 41′ and the first long edge 371′ of the ground portion 37′. A second slit 43′ is formed between the feed-in portion 41′ and the shorting portion 39′ and is connected to the first slit 42′. Between the ground portion 37′ and the shorting portion 39′ is a first fold line 35′. The radiating portion 38′ has a second fold line 36′ with the shorting portion 39′ and the feed-in portion 41′. The shorting portion 39′ is folded along the first fold line 35′ by bending 90° in the upward direction. The radiating portion 38′ is folded along the second fold line 36′ by bending 90 toward the direction of the ground portion 37′. The small shorted patch antenna structure shown in FIG. 11 differs from the first embodiment by having both the shorting portion 39′ and the feed-in portion 41′ located on the long edges 371′, 381′ that are on the same side, and achieves the same effects as the first embodiment.

As described above, the embodiments use one single metal plate that is stamped to form a first slit 42 (42′) and the second slit 43(43′) between the ground portion 37(37′) and the radiating portion 38(38′), and the shorting portion 39 (39′) and the radiating portion 38 (38′) are folded along the first fold line 35(35′) and the second fold line 36(36′) to form a small shorted patch antenna. Not only is the antenna simple in structure, the manufacturing process is also simple and the manufacturing cost is low. Also, the shorting portion 39(39′) and the feed-in portion 41 (41′) are both located on the same side on the antenna, allowing the antenna to be installed easily and flexibly inside an electronic device. Moreover, by having the ground portion 37(37′) serve as a shield, whether or not the antenna is set up on the side or on top of a metal component, it would not affect the impedance matching and the radiation efficiency.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A patch antenna comprising:
a metal plate having two substantially parallel long edges and two short edges connecting to said two parallel long edges, said metal plate further having a first fold line and a second fold line that are substantially parallel to said two short edges of said metal plate and that partition said metal plate into a ground portion on one side of said first fold line and a radiating portion on one side of said second fold line, said ground portion having a length longer than a length of said radiating portion and not longer than twice the length of said radiating portion;
wherein said metal plate further has a shorting portion between said first fold line and said second fold line and connecting said ground portion and said radiating portion, and a feed-in portion extending from said second fold line toward said first fold line, said feed-in portion forming a first slit with said ground portion, said feed-in portion forming a second slit with said shorting portion, said first slit being connected to said second slit,
said shorting portion being folded relative to said ground portion along said first fold line such that said shorting portion and said feed-in portion are substantially perpendicular with respect to said ground portion,
said radiating portion being folded relative to said shorting portion and said feed-in portion along said second fold line such that said radiating portion is substantially perpendicular with respect to said shorting portion and said feed-in portion and such that said radiating portion is spaced apart from said ground portion,
said two short edges being located on a same side of said first fold line.

2. The patch antenna according to claim 1, wherein the length of said ground portion is 1.6 times the length of said radiating portion.

3. The patch antenna according to claim 1, wherein each of said first slit and said second slit has a slit width of 1 mm.

4. A patch antenna comprising:
a ground portion having a first long edge and a second long edge opposite to each other, and a first short edge and a second short edge opposite to each other and each connected to said first long edge and said second long edge;
a radiating portion spaced apart from said ground portion and having a third long edge and a fourth long edge opposite to each other, and a third short edge and a fourth short edge opposite to each other and each connected to said third long edge and said fourth long edge, said third short edge being aligned with said first short edge, said second short edge and said fourth short edge being located on a same side of said first short edge;
a shorting portion having a first side connected to said first short edge of said ground portion, and a second side opposite to said first side and connected to said third short edge of said radiating portion; and
a feed-in portion connected to said third short edge of said radiating portion, extending from said third short edge towards said first short edge, forming a first slit with said first short edge, and forming a second slit with said shorting portion, said first slit and said second slit being interconnected.

5. The patch antenna according to claim 4, wherein said first short edge, said second short edge, said third short edge and said fourth short edge are equal in length, said first long edge and said second long edge are equal in length, said third long edge and said fourth long edge are equal in length, and the length of said first long edge is longer than the length of the third long edge and is shorter than twice the length of said third long edge.

6. The patch antenna according to claim 4, wherein each of said first slit and said second slit has a slit width of 1 mm.

7. A patch antenna comprising:
a ground portion having a first long edge and a second long edge opposite to each other, and a first short edge and a second short edge opposite to each other and each connected to said first long edge and said second long edge;
a radiating portion spaced apart from said ground portion and having a third long edge and a fourth long edge opposite to each other, and a third short edge and a fourth short edge opposite to each other and each connected to said third long edge and said fourth long edge, said third long edge being aligned with said first long edge, said second short edge and said fourth short edge being located on a same side of said first short edge;
a shorting portion having a first side connected to said first long edge of said ground portion, and a second side opposite to said first side and connected to said third long edge of said radiating portion; and
a feed-in portion connected to said third long edge of said radiating portion, extending from said third long edge towards said first long edge, forming a first slit with said first long edge, and forming a second slit with said shorting portion, said first slit and said second slit being interconnected.

8. The patch antenna according to claim 7, wherein said first short edge, said second short edge, said third short edge and said fourth short edge are equal in length, said first long edge and said second long edge are equal in length, said third long edge and said fourth long edge are equal in length, and the length of said first long edge is longer than the length of said third long edge and is shorter than twice the length of said third long edge.

9. The patch antenna according to claim 7, wherein each of said first slit and said second slit has a slit width of 1 mm.
